(19) United States
(12) Patent Application Publication
(10) Pub. No.: US 2017/0267455 A1
(43) Pub. Date: Sep. 21, 2017

(54) HIGH TEMPERATURE CONVEYOR BELT

(71) Applicant: CAMBRIDGE INTERNATIONAL, INC., Cambridge, MD (US)

(72) Inventors: Larry Vaughn WINDSOR, JR., Woolford, MD (US); William CANNON, Cambridge, MD (US); Alan Scott HENRY, East New Market, MD (US); Brian Jon ROBINSON, Hurlock, MD (US); Jason Vance TODD, Cambridge, MD (US); Ralph Buck TRAVIS, JR., Hurlock, MD (US); Robert E. MAINE, JR., Salisbury, MD (US); Thomas Claude ROSS, Fruitland, MD (US)

(73) Assignee: CAMBRIDGE INTERNATIONAL, INC., Cambridge, MD (US)

(21) Appl. No.: 15/457,542

(22) Filed: Mar. 13, 2017

Related U.S. Application Data
(60) Provisional application No. 62/308,476, filed on Mar. 15, 2016.

(51) Int. Cl. B65G 17/08; B21B 1/16

(52) U.S. Cl. CPC B65G 17/083; B21B 1/166

(57) ABSTRACT

A conveyor belt configured for a direction of travel, the conveyor belt including a plurality of connecting rods; and a spiral overlay; wherein each of the connecting rods has a flattened oblong cross section. In addition, a method a manufacturing a connector rod for a conveyor, belt includes providing a connector rod having a circular cross section; rolling the connector rod along a longitudinal axis thereof, and thereby producing a flattened oblong cross section.

### TECHNICAL FIELD

The disclosure herein is directed to a high temperature conveyor belt, and more particularly to an improved cross rod for use in a high temperature conveyor belt, and a method of forming the cross rod.

### BACKGROUND

High temperature conveyor belt applications generally range from 1500 to 2200° F. A wide variety of operations are performed in this temperature range including copper brazing, sintering of stainless steel/steel, stainless steel annealing, and tiring and glazing of ceramics in conveyorized furnaces.

Depending on the maximum tension, maximum temperature, belt speed, product load, operating atmosphere, and corrosive contaminants, both the alloy used in the construction of the belt and the belt design can be selected to give the maximum life possible with current technology. Currently used mechanical belt technologies include, but are not limited to, balanced belting, double balanced belting, balanced flat seat, and knuckleback belting.

With reference to FIGS. 1A and 1B, balanced conveyor belting comprises alternating clockwise and counter clock-wise wound spirals connected with crimped, (sine wave shaped) or straight connecting rods. The two illustrated examples show crimped cross rods and welded selvage edges. The cross section of the wires used in the spirals and rods are circular and the edges have welded selvages. This belt design allows for a higher number of spiral loops per foot of width and runs straighter than older obsolete designs, but results in excessive belt stretch/elongation due to the oval shape of the helical spirals. It also has a tendency to fray at the edges in service which can result in catastrophic failure.

A variation of the balanced belt, the double balanced belting design includes pairs of interlaced clock-wise and counter clock-wise helical spirals connected with crimped, (sine wave shaped) or straight connecting rods, as shown in FIG. 2. The cross section of the wires used in the spirals are typically circular and the edges also have welded selvaues. This design allows for a higher tensile strength than balanced belting but at much greater belt weight and cost. This design is rarely used today due to these issues. It also has the tendency to fray at the edges in service which can result in catastrophic failure.

Balanced flat seat belts, another variation of the balanced belt, comprise alternating clockwise and counter clock-wise wound spirals connected with crimped, (sine wave shaped), rods, as shown in FIG. 3. The cross section of the wires used in the spirals are flattened instead of circular and the cross section of the spiral/helix is much flatter. FIG. 4A illustrates the difference a flatter helix/spiral (shown in broken lines) versus the oval shaped balanced spiral. FIGS. 4B and 4C illustrate the difference between the wire cross section and spiral shape of the balanced flat seat (FIG. 4B) and balanced spirals (FIG. 4C). This belt design has less belt stretch/elongation than the older designs and allows for a higher strength to weight ratio than balanced or double balanced systems. It has one remaining mechanical limitation though in that the belt tends to fail and fray at the edges, which can result in catastrophic failure.

Knuckleback belting, yet another variation of the balanced belt, includes alternating clockwise and, counter clock-wise wound spirals connected with crimped, (sine wave shaped), rods, as shown in FIGS. 5A and 5B. The cross section of the wires used in the spirals are typically flattened instead of circular. Additionally, it has a double shear weld on the outer edges. This belt design has the same advantages of balanced flat seat belting, (less belt stretch/elongation than the older designs and allows for a higher strength to weight ratio than balanced or double balanced systems), and also reduces the tendency of other belt designs to fray at the edges with the use of the double shear weld. This design typically achieves an increase of life in the 30% range over the older designs with fewer catastrophic failures.

Although knuckleback belting has been able to optimize a very good application solution in relation to the mechanics of belt design, (belt elongation due to spiral flattening/straightening as well as reduced edge fraying), it does not effectively attack one of the single biggest issues involving high temperature applications. This issue involves the phenomena known in metallurgy as creep, (deformation).

Creep is the tendency of a solid material to slowly deform permanently under the influence of mechanical stresses that are still below the yield point of the base material. Creep is exponentially more severe in materials that are subjected to high temperatures for prolonged long periods or multiple short cycles and generally increases as temperatures reach the material's melting point.

This phenomenon dramatically shortens belt life in high temperature furnaces especially if the load is moderately uneven. This typically causes an effect known in the industry as: “camber”. Camber is localized creep of areas of belting, (predominantly deformation of the rods which then leads to spiral distortions and failure of both components). Camber in a conveyor belt appears as if the belt has waves in it versus the components appearing to be perpendicular to the direction of travel. As the belt “cambers”, hinging and articulation of the belt around the end rollers in the system become more difficult and this lack of hinging ultimately results in fatigue failures of the spiral and cross-rods.

Due to this issue, there is a market need for a belt configuration that resists camber for longer periods of time, has improved fatigue resistance and also has improved fraying resistance, (more than what knuckleback provides).

### SUM MARY

The disclosure herein provides a conveyor belt configured for a direction of travel, the conveyor belt comprising a plurality of connecting rods; and a spiral overlay; wherein each of said connecting rods has a flattened oblong cross-section.

According to a further aspect of the disclosure, the plurality of connecting rods are formed from a metal material and have an elongated material grain in a direction perpendicular to the direction of travel of the conveyor belt.

Another aspect of the disclosure is directed to a method a manufacturing a connector rod for a conveyor belt comprising providing a connector rod having a circular cross section; rolling the connector rod along a longitudinal axis thereof and thereby producing a flattened oblong cross section.

### BRIEF DESCRIPTION OF THE DRAWING FIGURES

These and other features and advantages of the disclosure will become more readily apparent to those skilled in the art upon reading the following detailed description, in conjunction with the appended drawings in which;

FIG. 1A is a plan view of a balanced wire conveyor belt according to the conventional art.

FIG. 1B is a plan view of another balanced wire conveyor bet, according to the conventional art.

FIG. 2 is a plan view of a double balanced wire conveyor belt according to the conventional art.

FIG. 3 is a plan view of a balanced flat seat wire conveyor belt according to the conventional art.

FIG. 4A illustrates the difference between a flatter helix/spiral versus the oval shaped balanced spiral according to the conventional art.

FIG. 4B and 4C illustrate the difference between the wire cross section and spiral shape of the balanced flat seat and balanced spirals according to the conventional art.

FIGS. 5A and 5B illustrate plan view of a knuckleback wire conveyor belt according to the conventional art.

FIGS. 6A and 6B illustrate a cross rod according to an exemplary embodiment of the disclosure herein.

FIG. 7 illustrates a conveyor bell including the cross rod according to an exemplary embodiment of the disclosure herein.

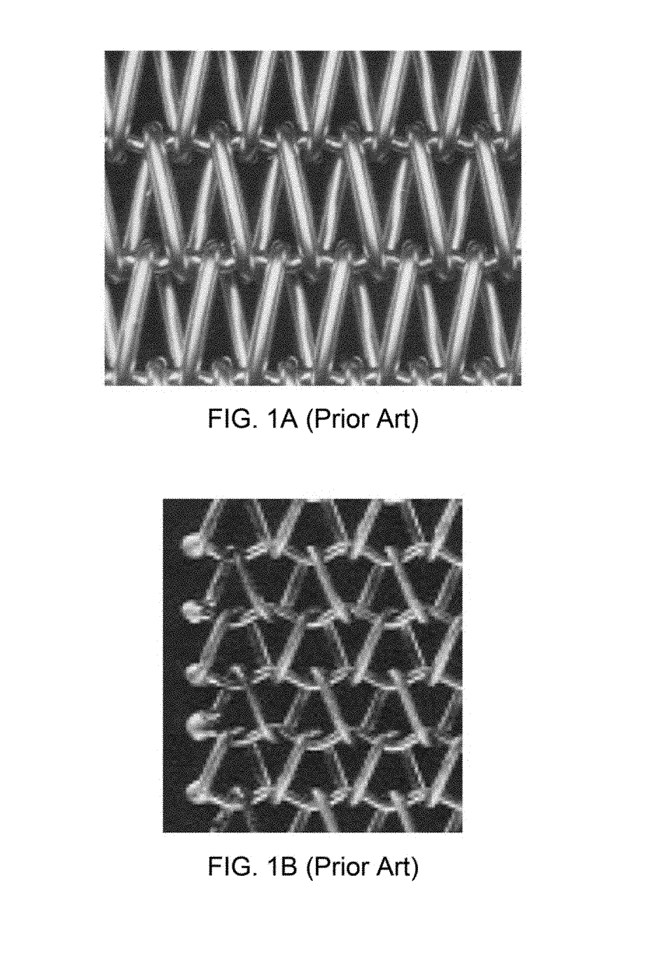

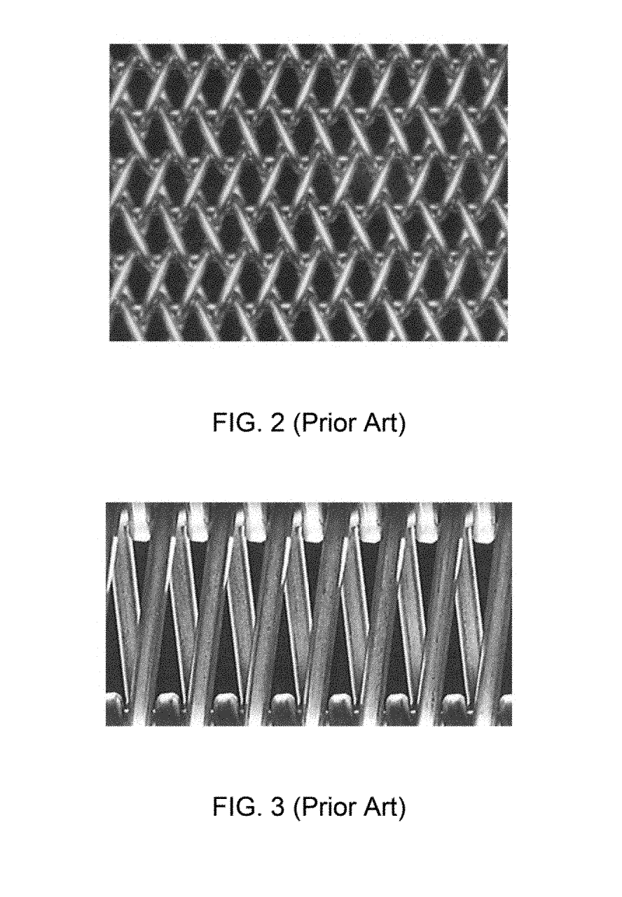

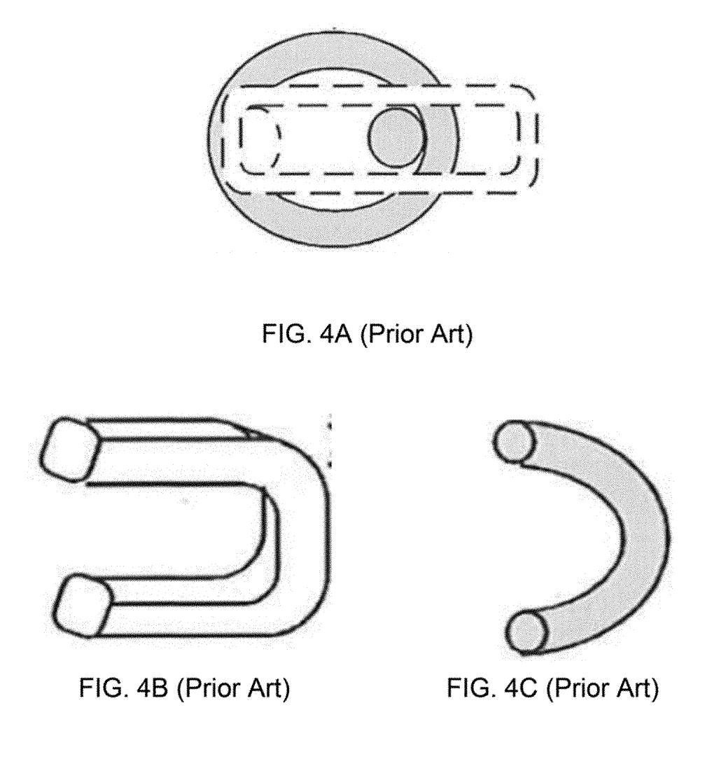

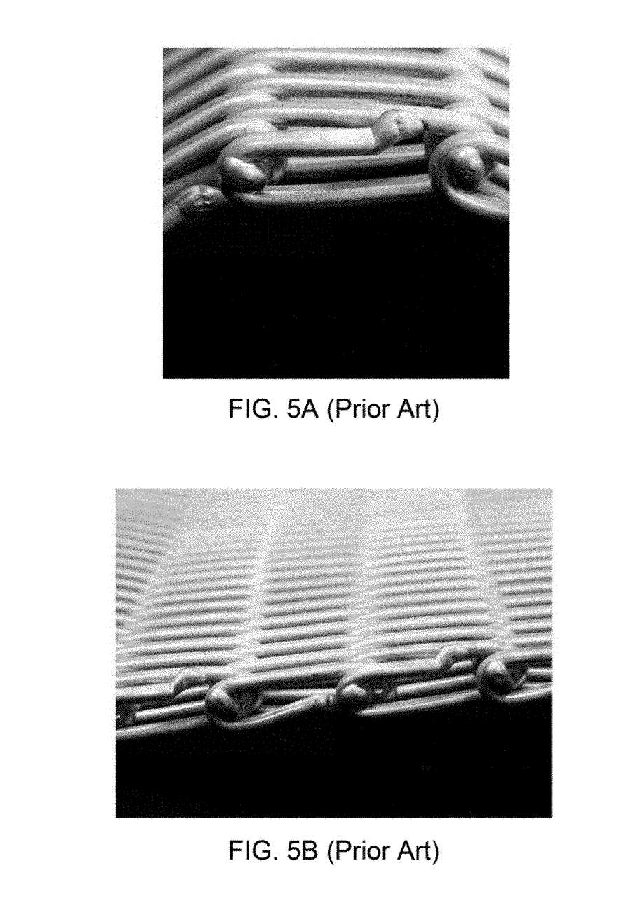

### DETAILED DESCRIPTION

To meaningfully improve camber resistance, the strength to weight ratio of the belt must be increased. A solution like double balanced belting or increasing the number of loops per foot of width in balanced belting, as done in the past, usually only gives a small increase in the strength to weight ratio because belt weight is a major factor in belt tension. Belt tension is a measure of the total load, (belt weight plus product weight) dragging across the product support surfaces. A 25% increase in belt strength and construction cost that also results in a 22% increase in belt weight only gives a minor increase in the strength to weight ratio.

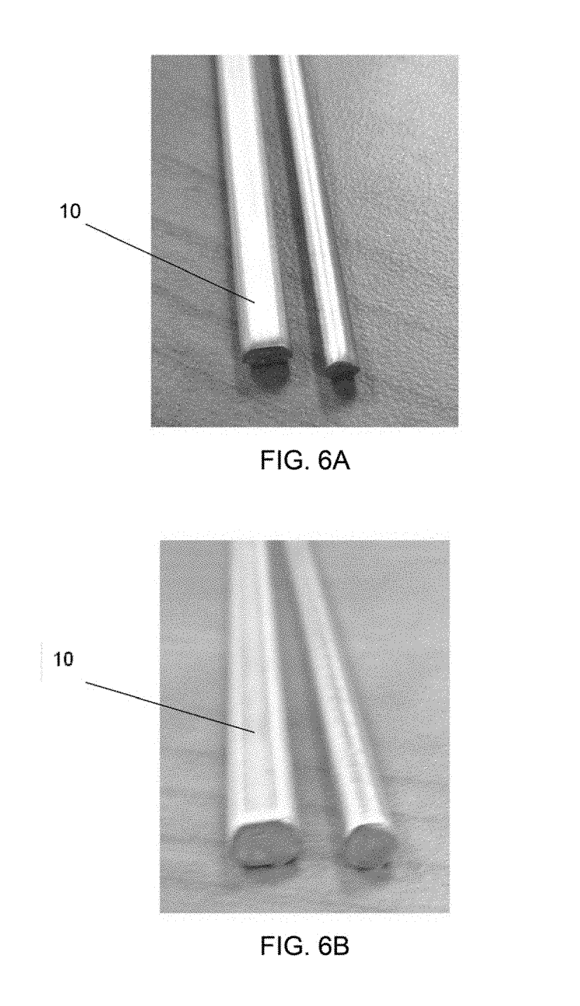

The disclosure herein provides an improved cross rod (connecting rod) that allows for an improved conveyor belt, and in particular, at knuckleback belt. Referring to FIGS. 6A and 6B, in an exemplary embodiment of the disclosure, an 8 gauge circular rod (shown on the right) is roll formed into a flattened oblong shape rod 10 (shown on the left). The grains of the material are rolled along the length of the rod and become elongated in a direction along the length of the rod, i.e., perpendicular to the shear load caused by the spirals in the spiral overlay engaging the rod in tension. The cross-sectional long edges of the rods are parallel to the direction of belt travel. This allows for a dramatically increased moment of inertia/resistance to shear and flexure. For example, replacing an 8 gauge, (0.148″ diameter cross rod with a flattened 0.148″×0.210″ rod gives a 38% increase in rod weight but with a 166% increase in camber resistance. Since the rods make up only nominally 10% of the weight of a belt but are a weak point for camber; the strength to weight ratio improves at even a higher rate. Alternatively, utilizing just a larger diameter cross rod also increases the thickness of the spirals and results in a larger weight gain, but yields a lower improvement in strength to eight ratio.

The rolled grain, structure of the rod 10 additionally increases the fatigue strength of the rods. The grain structure impairs crack migration, so even when the improved rod 10 eventually creeps it will also have a delayed fatigue failure not only due to the extra material through which the crack must propagate, but also the grain structure it must traverse. Simulations and tests suggest a nominal 30-40% improvement in fatigue life of components after camber takes place.

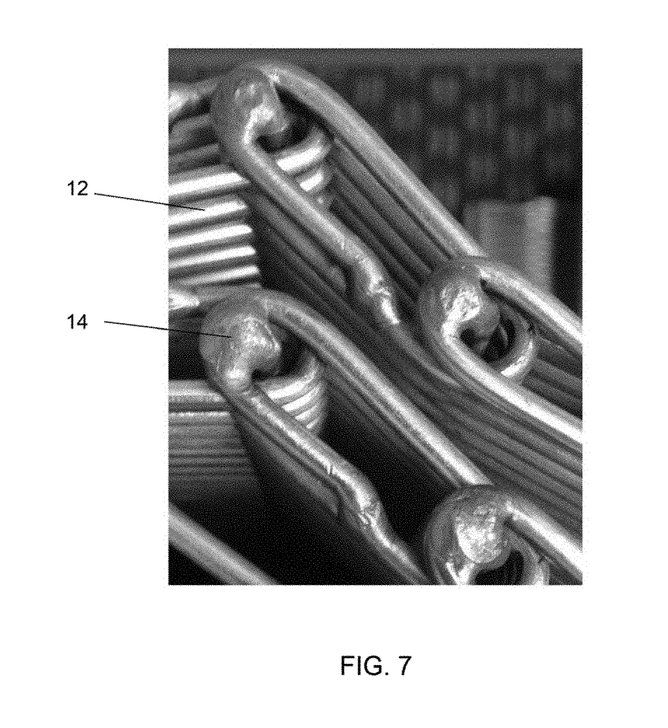

Referring also to FIG. 7, the flattened rod allows for a larger rear shear weld 14 in the double shear weld of a knuckleback conveyor belt 12 (an increase of nominally 40% in size). Multiple finite element analysis (FEA) models were run to determine the optimal angle of the knuckled edge components, (67 degrees), and the optimal size of the associated welds. An increase of fraying resistance of 25% is projected for the improved double shear weld.

In summary, the disclosure herein provides for the utilization of a cross rod that is roll formed into a flattened oblong shape with an elongated grain structure perpendicular to the shear load caused by the spirals engaging the rod in tension. The cross-sectional long, edges of the cross rods are parallel to the direction of belt travel. This allows for a dramatically increased moment of inertia/resistance to shear and flexure. Additionally, the rod also improves fatigue strength and life of the assembly, increases the strength-to-weight ratio and allows for a more fray resistant belt edge due to the larger shear welds.

While the disclosure herein has been described with respect to exemplary embodiments of the invention, this is by way of illustration for purposes of disclosure rather than to confine the invention to any specific arrangement as there are various alterations, changes, deviations, eliminations, substitutions, omissions and departures which may be made in the particular embodiment shown and described without departing from the scope of the claims.

1. A conveyor belt configured for a direction of travel, the conveyor belt comprising:
a plurality of connecting rods; and
a spiral overlay;
wherein each of said connecting rods has a flattened oblong cross section.

2. The conveyor belt according to claim 1, wherein the plurality of connecting rods are formed from a metal material and have an elongated material grain in a direction perpendicular to the direction of travel of the conveyor belt.

3. In a conveyor belt comprising a plurality of connecting rods and a product support surface overlay, the improvement comprising:
said plurality of connecting rods having a flattened oblong cross-sectional shape.

4. The improvement of claim 3, wherein the plurality of connecting rods are formed from a metal material and a grain of the metal material is elongated in a direction of a longitudinal axis of the connecting rod.

5. A method a manufacturing a connector rod for a conveyor belt comprising:
providing a connector rod having a circular cross section;
rolling the connector rod along a longitudinal axis thereof and thereby producing a flattened oblong cross section.
